(19) United States
(12) Patent Application Publication
(10) Pub. No.: US 2024/0063896 A1
(43) Pub. Date: Feb. 22, 2024

(54) SATELLITE ACCESS WITH NON-CONTINUOUS COVERAGE

(71) Applicant: QUALCOMM Incorporated, San Diego, CA (US)

(72) Inventors: Amer CATOVIC, San Diego, CA (US); Bharat SHRESTHA, San Diego, CA (US); Alberto RICO ALVARINO, San Diego, CA (US); Haris ZISIMOPOULOS, London (GB); Lenaig Genevieve CHAPONNIERE, La Jolla, CA (US); Ayan SENGUPTA, San Diego, CA (US); Umesh PHUYAL, San Diego, CA (US)

(21) Appl. No.: 18/269,275

(22) PCT Filed: Feb. 22, 2022
(86) PCT No.: PCT/US2022/017391

§ 371 Date: Jun. 22, 2023

(30) Foreign Application Priority Data
Feb. 22, 2021 (GR) 20210100109

(51) Int. Cl. H04B 7/185

(52) U.S. Cl. CPC H04B 7/18517; H04B 7/18513

(57) ABSTRACT

Aspects presented herein relate to methods and devices for wireless communication of an apparatus, e.g., a UE, a network entity, and/or a base station. The apparatus may receive, from a network, an indication of at least one of a coverage re-visit time or a backhaul connection unavailability. The apparatus may also identify, based on the received indication, whether to initiate at least one of a signaling procedure or a data packet procedure, the signaling procedure and the data packet procedure being associated with at least one of the coverage re-visit time or the backhaul connection unavailability. The apparatus may also initiate at least one of a signaling procedure or a data packet procedure based on the indication of the coverage re-visit time or the backhaul connection unavailability, the signaling procedure and the data packet procedure being associated with the coverage re-visit time or the backhaul connection unavailability.

### CROSS REFERENCE TO RELATED APPLICATION(S)

This application claims the benefit of and priority to Greek Patent Application Serial No. 20210100109, entitled “METHODS AND APPARATUS FOR HANDLING SATELLITE ACCESS WITH NON-CONTINUOUS COVERAGE” and filed on Feb. 22, 2021, which is expressly incorporated by reference herein in its entirety.

### TECHNICAL FIELD

The present disclosure relates generally to communication systems, and more particularly, to satellite access networks in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). In some aspects, the apparatus may receive, from a network, satellite ephemeris data; and identify at least one of a coverage re-visit time or a backhaul connection unavailability based on the satellite ephemeris data. The apparatus may also receive, from a network, an indication of at least one of a coverage re-visit time or a backhaul connection unavailability. The apparatus may also identify, based on the received indication, whether to initiate at least one of the signaling procedure or the data packet procedure, where the identification whether to initiate at least one of the signaling procedure or the data packet procedure is performed prior to the initiation of the at least one of a signaling procedure or a data packet procedure. Additionally, the apparatus may initiate at least one of a signaling procedure or a data packet procedure based on the indication of at least one of the coverage re-visit time or the backhaul connection unavailability, the signaling procedure and the data packet procedure being associated with at least one of the coverage re-visit time or the backhaul connection unavailability. In some instances, when the signaling procedure is initiated, the apparatus may also initiate a timer for the duration of the coverage re-visit time; or initiate the power saving mode at the UE. The apparatus may also adjust a length of the timer based on the duration of the coverage re-visit time. In some aspects, when the data packet procedure is initiated, the apparatus may also transmit at least one data packet; cancel a transmission of at least one data packet; or postpone a transmission of at least one data packet. Moreover, the apparatus may receive, from the network, an indication of a data transmission when the backhaul connection is available; and identify whether to re-transmit the data transmission when the backhaul connection is available.

In an aspect of the disclosure, a method, a computer-readable medium, and an apparatus are provided. The apparatus may be a network entity or a base station. In some aspects, the apparatus may obtain at least one of a coverage re-visit time or a backhaul connection unavailability, at least one of the coverage re-visit time or the backhaul connection unavailability being associated with at least one of a signaling procedure of at least one user equipment (UE) or a data packet procedure of the at least one UE. The apparatus may also transmit, to the at least one UE, satellite ephemeris data, where at least one of the coverage re-visit time or the backhaul connection unavailability is based on the satellite ephemeris data. The apparatus may also transmit, to the at least one UE, an indication of at least one of the coverage re-visit time or the backhaul connection unavailability. Further, the apparatus may receive, from the at least one UE, at least one data packet. The apparatus may also transmit, to the at least one UE, an indication of a data transmission when the backhaul connection is available, where a re-transmission of the data transmission is based on when the backhaul connection is available.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example satellite access network.

FIG. 5 is a diagram illustrating example communication between a UE and a satellite access network.

FIG. 6 is a diagram illustrating example communication between a UE and a base station.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus.

FIG. 12 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

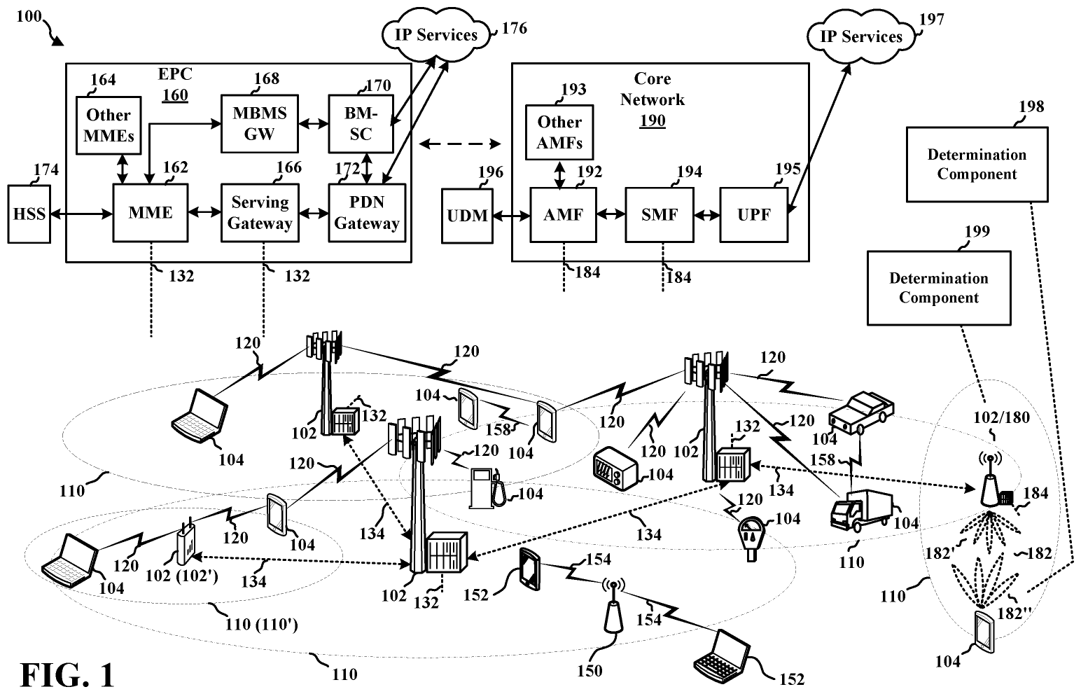

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A network node can be implemented as a base station (i.e., an aggregated base station), as a disaggregated base station, an integrated access and backhaul (IAB) node, a relay node, a sidelink node, etc. A network entity can be implemented as a base station (i.e., an aggregated base station), or alternatively, as a central unit (CU), a distributed unit (DU), a radio unit (RU), a Near-Real Time (Near-RT) RAN Intelligent Controller (RIC), or a Non-Real Time (Non-RT) RIC in a disaggregated base station architecture.

Referring again to FIG. 1, in certain aspects, the UE 104 may include a determination component 198 configured to receive, from a network, satellite ephemeris data; and identify at least one of a coverage re-visit time or a backhaul connection unavailability based on the satellite ephemeris data. Determination component 198 may also be configured to receive, from a network, an indication of at least one of a coverage re-visit time or a backhaul connection unavailability. Determination component 198 may also be configured to identify, based on the received indication, whether to initiate at least one of the signaling procedure or the data packet procedure, where the identification whether to initiate at least one of the signaling procedure or the data packet procedure is performed prior to the initiation of the at least one of a signaling procedure or a data packet procedure. Determination component 198 may also be configured to initiate at least one of a signaling procedure or a data packet procedure based on the indication of at least one of the coverage re-visit time or the backhaul connection unavailability, the signaling procedure and the data packet procedure being associated with at least one of the coverage re-visit time or the backhaul connection unavailability. In some instances, when the signaling procedure is initiated, determination component 198 may also be configured to initiate a timer for the duration of the coverage re-visit time; or initiate the power saving mode at the UE. Determination component 198 may also be configured to adjust a length of the timer based on the duration of the coverage re-visit time. In some aspects, when the data packet procedure is initiated, determination component 198 may also be configured to transmit at least one data packet; cancel a transmission of at least one data packet; or postpone a transmission of at least one data packet. Determination component 198 may also be configured to receive, from the network, an indication of a data transmission when the backhaul connection is available; and identify whether to re-transmit the data transmission when the backhaul connection is available.

Referring again to FIG. 1, in certain aspects, the base station 180 may include a determination component 199 configured to obtain at least one of a coverage re-visit time or a backhaul connection unavailability, at least one of the coverage re-visit time or the backhaul connection unavailability being associated with at least one of a signaling procedure of at least one user equipment (UE) or a data packet procedure of the at least one UE. Determination component 199 may also be configured to transmit, to the at least one UE, satellite ephemeris data, where at least one of the coverage re-visit time or the backhaul connection unavailability is based on the satellite ephemeris data. Determination component 199 may also be configured to transmit, to the at least one UE, an indication of at least one of the coverage re-visit time or the backhaul connection unavailability. Determination component 199 may also be configured to receive, from the at least one UE, at least one data packet. Determination component 199 may also be configured to transmit, to the at least one UE, an indication of a data transmission when the backhaul connection is available, where a re-transmission of the data transmission is based on when the backhaul connection is available.

Although the following description may be focused on 5G NR, the concepts described herein may be applicable to other similar areas, such as LTE, LTE-A, CDMA, GSM, and other wireless technologies.

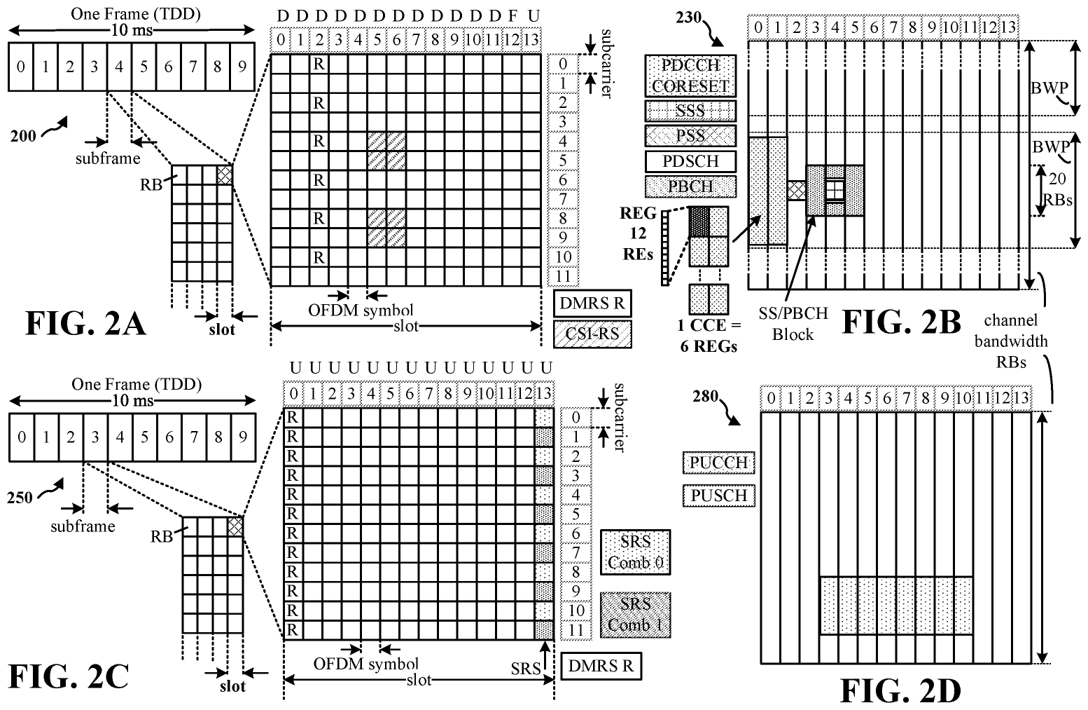

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARD) acknowledgment (ACK) (HARQ-ACK) information (ACK/negative ACK (NACK)) feedback. The PUSCH carries data, and may additionally be used to carry a buffer status report (BSR), a power headroom report (PHR), and/or UCI.

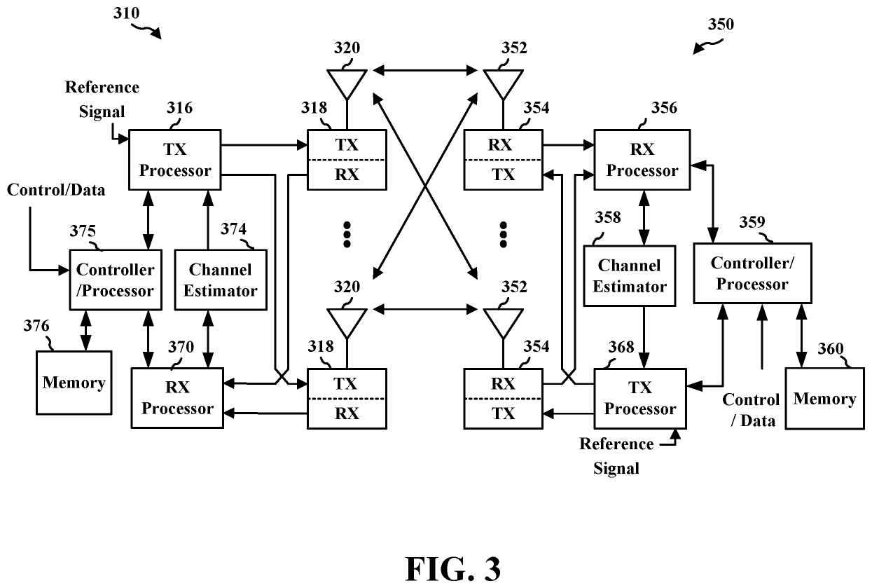

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

Satellite access networks are wireless communication networks where satellites provide communication access within a certain coverage area, i.e., a coverage cell or a radio cell. The coverage cells in a satellite access networks may include a size that is one or two orders of magnitude larger than cells in terrestrial access networks. For example, terrestrial access networks may include a cell diameter of a few miles, whereas satellite access networks may include a cell diameter of several hundred miles. Further, in satellite access networks, cell transmitters may be on the orbiting satellites, such that each cell is moving at the same rate as the corresponding satellite. Accordingly, as each satellite moves around the earth, the corresponding radio cell coverage area moves along with the satellite. For example, for a cell with a 1000 km cell diameter and a satellite speed of 7.56 km/s, a UE on the ground may be in the coverage of the cell for about 132.2 seconds (i.e., 2.2 minutes).

In some satellite access networks, there may be coverage gaps between the cell coverage of adjacent satellites. In these satellite access networks, the coverage for a particular UE may not be continuous, such as when the UE is in a coverage gap between the cell coverage of adjacent satellites. For example, the coverage gap between satellites may correspond to the amount of time between the coverage of successive cells (i.e., a coverage re-visit time). For example, a coverage re-visit time may be an amount of time, e.g., 10 to 40 min., that depends on the amount of satellites deployed in the network, as well as the rate of movement of the satellites in the network. In some instances, this coverage gap between successive satellites may be predesigned or predetermined based on the network.

Additionally, satellites may or may not have a backhaul connection, i.e., a backhaul gateway, to a core network on the ground. In some aspects, when a UE connects to a particular satellite, the satellite may not have a backhaul connection to a core network. For instance, the backhaul connection between the satellite and the core network may lose connection, or have intermittent connectivity, due to the movement of the satellite. In other aspects, when a satellite has a backhaul connection to the core network on the ground, the UE may be outside of the coverage cell of the satellite. As such, satellite networks may experience multiple types of connection interruptions, e.g., radio transmission interruptions with a UE and/or backhaul connection interruptions with a core network. These connection interruptions may be based on the density of the orbiting satellites, as well as the density of the backhaul gateways on the ground.

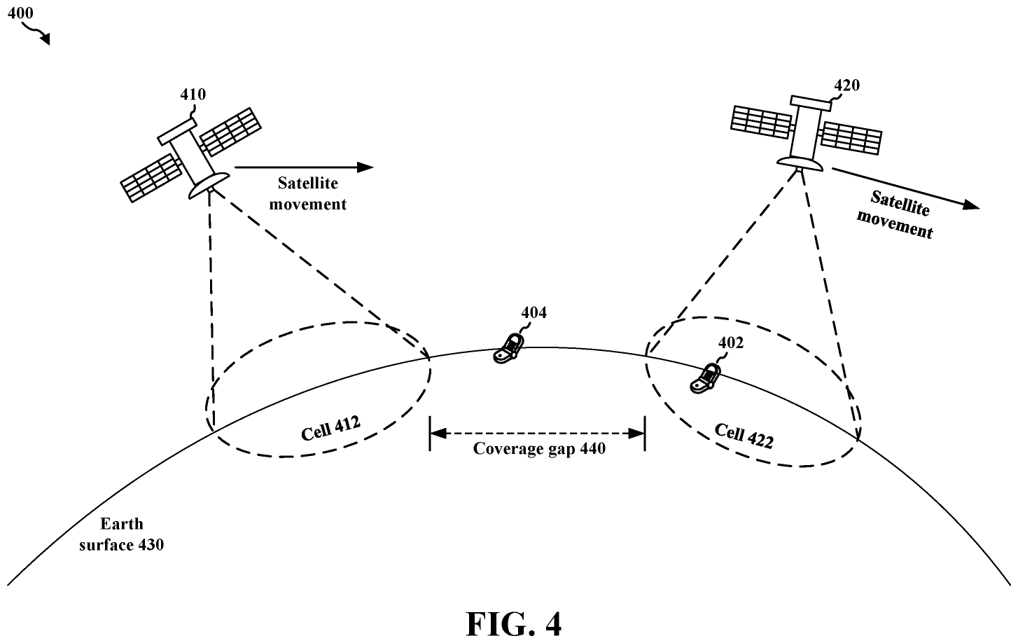

FIG. 4 is a diagram 400 illustrating an example satellite access network. As shown in FIG. 4, the satellite access network includes a number of satellites, e.g., satellites 410 and 420, and a number of UEs, e.g., UEs 402 and 404. Each of the satellites 410 and 420 includes a coverage cell, i.e., cell 412 for satellite 410 and cell 422 for satellite 420. As shown in FIG. 4, the cell coverage is not continuous between satellites 410 and 420, so there is a coverage gap between cell 412 and cell 422, e.g., coverage gap 440. UE 404 is between the coverage of cells 412 and 422, so UE 404 is considered to be in coverage gap 440. Also, UE 402 is within cell 422, so UE 402 is within the coverage area for satellite 420. As satellites 410 and 420 move in one direction, the corresponding cells 412 and 422 move along with them. Additionally, satellites 410 and 420 may have a backhaul connection to a core network (not shown) on the ground, e.g., on earth surface 430. This core network may also be considered part of the satellite access network.

UEs in satellite access networks are generally farther away from base stations compared to UEs in terrestrial access networks. Accordingly, the round trip time (RTT) (i.e., the length of time for a data packet to be sent to a destination plus the time for an acknowledgment of that packet to be received) for satellite access networks may be longer than the RTT for terrestrial access networks. For instance, for geosynchronous equatorial orbit (GEO) satellites, an example regenerative scenario may include a RTT of 270.73 ms. Moreover, for GEO satellites, an example transparent scenario may include a RTT of 541.46 ms. For low earth orbit (LEO) satellites, an example regenerative scenario of 600 km may include a RTT of 12.89 ms. Additionally, for LEO satellites, an example transparent scenario of 600 km may include a RTT of 25.77 ms.

In some instances, a UE in a satellite access network may be in idle mode, where the UE may not have a connection with the network at a non-access stratum (NAS) protocol layer. For instance, when a UE is in idle mode, the loss of radio coverage may cause the UE to enter into an out-of-service (OOS) state at the access stratum (AS) protocol layer. At the NAS layer, the UE may first enter into a public land mobile network (PLMN) search state, i.e., a PLMN-SEARCH state. After this, if the search is unsuccessful, the UE may transition to a state indicating there are no available cells, i.e., a NO-CELL-AVAILABLE state. In the PLMN-SEARCH and the NO-CELL-AVAILABLE states, the UE may intermittently perform frequency scans looking for networks. Also, the frequency scans in the NO-CELL-AVAILABLE state may be less frequent than in the PLMN-SEARCH state. These frequency scans may also take a substantial toll on the battery life at the UE. Further, when a UE is in idle mode there may be no connection to the core network, so the backhaul connection may not be utilized. As such, the loss of a backhaul connection may not have an impact on UEs in idle mode.

Additionally, a UE in a satellite access network may be in connected mode, where the UE may have an active radio link and a NAS signaling protocol connection with the network over the radio link. For instance, in connected mode, a loss of radio coverage may trigger a radio link failure (RLF) at the AS layer and/or a loss of NAS signaling connection at the NAS layer. Due to a persistent lack of coverage, the radio link may not be recovered and the UE may enter into an OOS state. After this, the steps performed by the UE may be similar to when the UE is in idle mode (e.g., the UE may first enter into a PLMN-SEARCH state, and if unsuccessful, the UE may transition to a NO-CELL-AVAILABLE state, etc.). These steps may occur during an ongoing NAS procedure, such as a registration procedure, or during a data transfer.

In some aspects, when the UE is in a connected mode, the loss of a backhaul link (e.g., if radio coverage exists) may result in a lack of response from the network for certain UE-initiated procedures (e.g., a registration procedure). Also, a NAS procedure supervision timer may time-out on the UE side (e.g., if the NAS signaling connection is not released by the network beforehand). In some instances, there may be multiple attempts by the UE to recover the backhaul link before the procedure is aborted. Further, when the UE is in connected mode, the loss of a backhaul link (e.g., if the radio coverage exists) may result in a data loss during a data transfer.

Based on the above, it may be beneficial for satellite access network UEs in idle mode to receive information about the duration of a coverage re-visit time. For satellite access network UEs in connected mode, it may be beneficial to receive information about a lack of a backhaul connection and/or the duration of the coverage re-visit time. Further, it may be beneficial for satellite access network UEs to receive an indication of an uplink data transfer, such as regarding whether data is buffered at the satellite node. Also, it may be beneficial to address an impact on the NAS layer based on a loss of radio coverage and/or a loss of a backhaul connection.

Aspects of the present disclosure may provide for satellite access network UEs in idle mode to obtain information about the duration of a coverage re-visit time. Aspects of the present disclosure may also provide for satellite access network UEs in connected mode to obtain information about a lack of a backhaul connection and/or the duration of the coverage re-visit time. Moreover, aspects of the present disclosure may provide for satellite access network UEs to obtain an indication of an uplink data transfer, such as regarding whether data is buffered at the satellite node. Aspects of the present disclosure may also address an impact on the NAS layer based on a loss of radio coverage and/or a loss of a backhaul connection.

In some aspects, for satellite access network UEs in idle mode and/or in an OOS state (e.g., a NO-CELL-AVAILABLE state), information regarding the duration of a coverage re-visit time may be utilized by the UE. This information of the coverage re-visit time may be obtained at the UE and/or at the network. Also, this information regarding coverage re-visit time may be used to optimize frequency scans by the UE and thus improve the battery life of the UE. For instance, the amount of frequency scans performed by the UE searching for a connection or network may be reduced based on the coverage re-visit time. Also, a frequency scan interval may be implementation specific, whereas the information about the coverage re-visit time may be signaled to the UE.

Additionally, for satellite access network UEs in connected mode, a UE may utilize information regarding a lack of a backhaul connection and/or the duration of the re-visit time for the backhaul connection. This information may allow for NAS procedure supervision timers in the UE to be extended in order to avoid ongoing procedures from failing due to a time out. For example, NAS procedure supervision timers may be extended from an initial time, e.g., 10 to 15 seconds, to the re-visit time, e.g., 10 min. Additionally, or alternatively, the procedure may be aborted and the UE may enter into a power saving mode (PSM) (e.g., a mobile-initiated connection only (MICO) state) until the backhaul connection is re-established. The duration of the power saving mode may be determined based on the duration of the coverage re-visit time. Further, for an uplink (UL) data transfer, if the data is buffered at the satellite node, there may be an indication to the UE regarding the data buffering. The UE may also adjust its data re-transmission policy based on the re-visit time and/or the delay specifications for the data.

In some aspects, satellite access network UEs may receive an indication from a network regarding a coverage re-visit time, where the coverage re-visit time may be expected or not expected by the UE. For example, the indication of a coverage re-visit time may be signaled directly in a system information block (SIB) or signaled to the UE via RRC signaling. The indication of a coverage re-visit time may also be determined or computed by the UE based on satellite ephemeris data (i.e., ephemeris data that is signaled to the UE from a satellite). Further, based on the coverage re-visit time indication, a UE may adjust or extend the interval between successive frequency scans, i.e., frequency scans performed by the UE searching for a connection or network. By reducing the amount of frequency scans over a time period, the UE may reduce the amount of battery life utilized at the UE.

In addition, satellite access network UEs may receive an indication from the network that a backhaul connection is not available, i.e., an indication of backhaul unavailability, which may include the coverage re-visit time. For example, this indication may be signaled directly in a SIB or signaled to the UE via RRC signaling. Also, when the indication is signaled to the UE, a “wait time” information element may be re-used or utilized for a new purpose associated with the coverage re-visit time and/or the backhaul connection unavailability (i.e., the information element is overloaded). This indication may also be determined or computed by the UE based on satellite ephemeris data. Further, based on the indication of backhaul unavailability, the UE may adjust the interval between successive frequency scans. Moreover, the indication of coverage re-visit time and/or backhaul unavailability may be associated with an indication from the AS layer to the NAS layer in the UE, i.e., the AS layer indicates to the NAS layer the lack of backhaul connection and/or the coverage re-visit time.

In some aspects, based on the indication of backhaul connection unavailability and/or the coverage re-visit time received from the AS layer, the NAS layer may extend one or more NAS procedure supervision timers. That is, the NAS procedure supervision timers may be extended by the duration of the coverage re-visit time. Additionally, based on the indication of backhaul connection unavailability and/or the coverage re-visit time received from the AS layer, the NAS layer may enter into a power saving mode for the duration of the re-visit time. In some instances, based on the indication of backhaul unavailability and/or the coverage re-visit time, an ongoing NAS signaling procedure may be canceled or aborted. For instance, if there is no backhaul connection available, there may be no corresponding NAS signaling, so the NAS signaling procedure may be canceled.

Further, in some aspects, after transferring data (e.g., a consumer internet of things (CIoT) data transfer associated with a control plane service request (CPSR) procedure), if the UE receives an indication of backhaul unavailability, the UE may determine whether to retransmit the data (i.e., when the backhaul link becomes available). As such, based on the indication, the UE may retransmit data, e.g., CIoT data, or not retransmit the data when the backhaul link becomes available. Additionally, after a CIoT data transfer (or during a CPSR procedure), the network may also indicate whether the data will be stored and forwarded when the backhaul link becomes available, i.e., a data store-and-forward process. The indication of the store-and-forward process may be transmitted along with, or separate from, the indication of backhaul unavailability and/or the coverage re-visit time.

In some instances, a UE may initiate a data store-and-forward process when a backhaul connection is not available. For example, a UE may drop or cancel data (i.e., when there is no service), forward data immediately to another satellite with a backhaul connection (e.g., a geosynchronous equatorial orbit (GEO) satellite), or store-and-forward the data at a later time. Also, a UE may be preconfigured with a list of networks that support a store-and-forward service and/or a forward immediately service. As such, when the UE determines it is in coverage of a network that supports either a store-and-forward service and/or a forward immediately service, the UE may utilize either the service in the network. In some aspects, a network may broadcast or indicate its support for each service (e.g., store-and-forward service and/or forward immediately service) in the SIB. A network may also broadcast or indicate its support for each service during a registration procedure over satellite access. Accordingly, upon registration with a network, the network may inform the UE of the supported services. In some instances, this data store-and-forward service may be provided by a network.

Additionally, UEs may invoke a service, e.g., a data store-and-forward service and/or a forward immediately service, in a number of different ways. For example, UEs may invoke a data store-and-forward service when sending data, e.g., via an indication in a CONTROL PLANE SERVICE REQUEST message. Also, UEs may invoke a data store-and-forward service when establishing an RRC connection, e.g., via an RRC CONNECTION REQUEST message. UEs may also invoke a data store-and-forward service during a registration procedure, e.g., via a REGISTRATION REQUEST message. In addition, in some instances, a UE's connectivity to a PLMN through an NTN may be intermittent due to either non-overlapping satellite coverage or the unavailability of a backhaul link. During such interruptions, a UE may be wasting power by executing procedures that are likely to fail. Based on a UE location and/or satellite trajectories, UEs according to the present disclosure may determine when such interruptions are likely to occur. UEs may use this information to delay or skip executing procedures (e.g., a cell search, a PLMN search, etc.) and/or adjust retransmission timers. In case of a backhaul failure, the satellite may implement a store-and-forward mechanism for traffic. The use of this procedure may be negotiated with the UE.

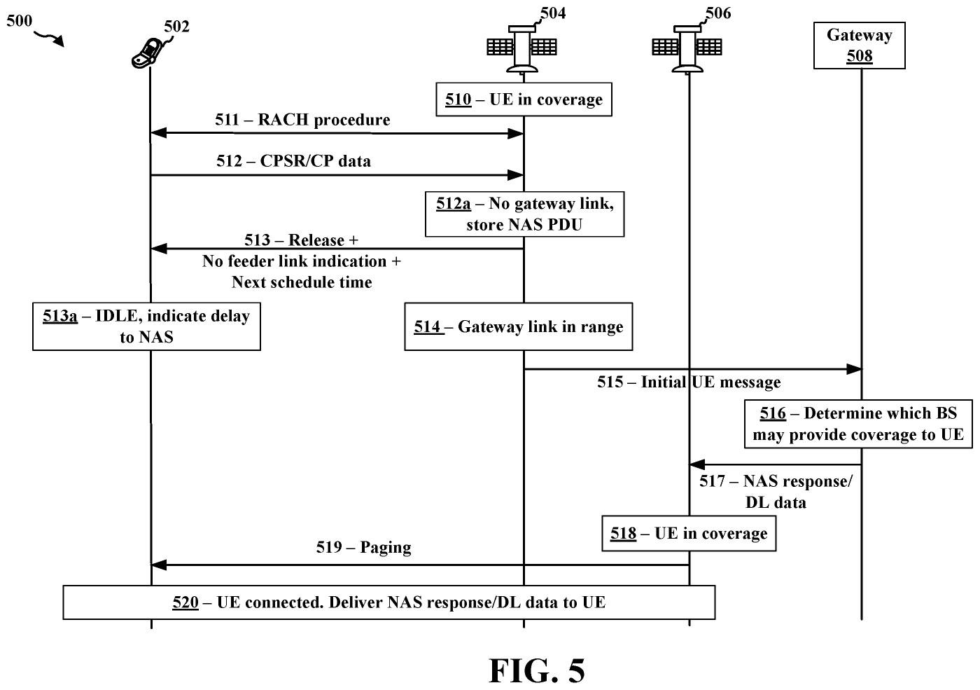

FIG. 5 is a diagram 500 illustrating communication between a UE 502 and a satellite access network including satellite base station (BS) 504, satellite BS 506, and gateway 508. The communication in diagram 500 may occur during an uplink data transmission when a backhaul connection is unavailable. As shown in FIG. 5, at step 510, the UE 502 is in coverage of the beam for satellite BS 504. At step 511, the UE 502 starts a RACH procedure with satellite BS 504. At step 512, the UE 502 sends a CPSR message, e.g., a CPSR message with CP data or a data packet, to the satellite BS 504. At step 512a, satellite BS 504 may determine that there is no gateway link and may store the NAS packet data unit (PDU). The storage of the NAS PDU at the satellite BS 504 may be associated with a store-and-forward process.

At step 513, the satellite BS 504 may transmit, to the UE 502, an indication and/or a release message. This indication may indicate that there is no feeder link, as well as indicate the coverage re-visit time. At step 513a, the UE 502 may enter into idle mode, as well as indicate a delay time to the NAS layer, e.g., via an ACK. At step 514, the satellite BS 504 may determine that a gateway link is reestablished or in range. At step 515, the satellite BS 504 may transmit an initial UE message to the gateway 508. Additionally, at step 516, the gateway 508 may determine which satellite BS may provide coverage for the UE 502. At step 517, the gateway 508 may transmit a NAS response and/or downlink data to the satellite BS 506. This response may be based on a prior message from the UE 502, e.g., a short message service (SMS) message. At step 518, the satellite BS 506 may determine that the UE 502 is within its coverage range. At step 519, the satellite BS 506 may transmit a paging message to the UE 502. At step 520, the UE 502 may be connected with the satellite BS 506. Also, the satellite BS 506 may deliver a NAS response and/or downlink data to the UE 502.

As shown in FIG. 5, once a UE is registered with a satellite access network, a control plane (CP) CIoT optimization may be used to transmit uplink data. A UE may also utilize a data store-and-forward approach and/or a forward immediately approach to transmit uplink data. In some instances, these approaches may result in an impact at the NAS layer of a UE. Further, the NAS layer at a UE may wait a certain amount of time, e.g., 10 to 40 min., in order to receive a response from the network.

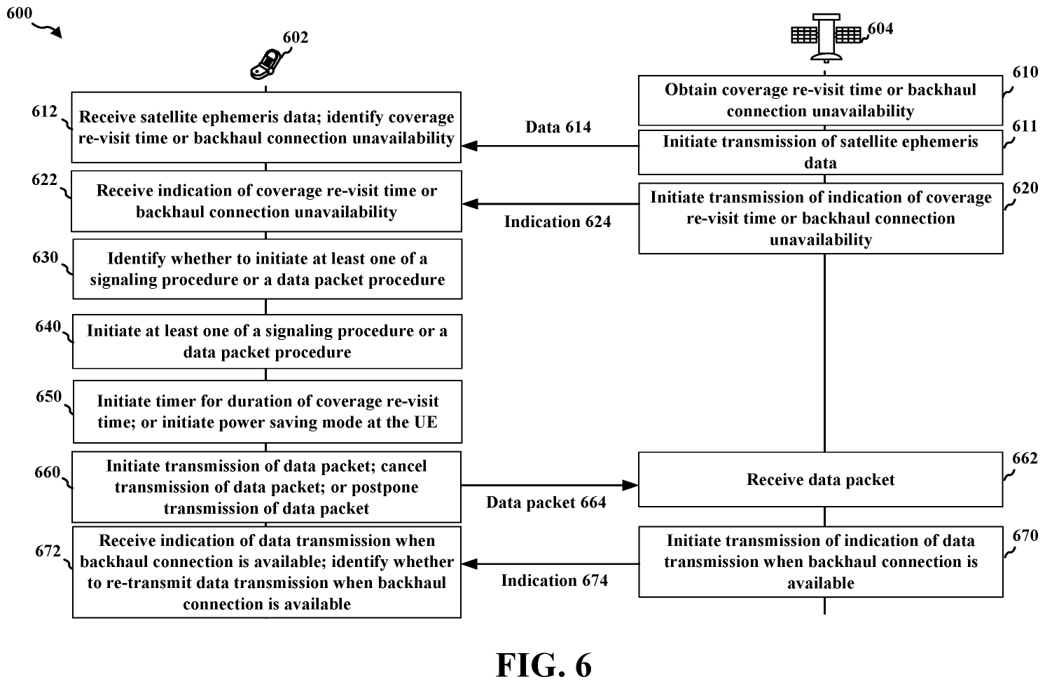

FIG. 6 is a diagram 600 illustrating communication between a UE 602 and a base station 604, e.g., a network entity in a network or a satellite base station in a satellite access network. The UE 602 may correspond to UE 104, 350, 402/404, 502, and apparatus 1102, and the base station 604 may correspond to base station 180, 310, 410/420, 504/506, and apparatus 1202.

At 610, base station 604 may obtain at least one of a coverage re-visit time or a backhaul connection unavailability, at least one of the coverage re-visit time or the backhaul connection unavailability being associated with at least one of a signaling procedure of at least one UE, e.g., UE 602, or a data packet procedure of the at least one UE. In some aspects, obtaining at least one of the coverage re-visit time or the backhaul connection unavailability may include at least one of: receiving a configuration of at least one of the coverage re-visit time or the backhaul connection unavailability; or retrieving the configuration of at least one of the coverage re-visit time or the backhaul connection unavailability from a storage or a memory location.

At 611, base station 604 may transmit, to at least one UE, e.g., UE 602, satellite ephemeris data, e.g., data 614, where at least one of the coverage re-visit time or the backhaul connection unavailability is based on the satellite ephemeris data. At 612, UE 602 may receive, from a network entity or base station 604, satellite ephemeris data, e.g., data 614; and identify at least one of a coverage re-visit time or a backhaul connection unavailability based on the satellite ephemeris data, e.g., data 614. The UE 602 may also obtain satellite ephemeris data.

At 620, base station 604 may initiate a transmission of, to the at least one UE, e.g., UE 602, an indication of at least one of the coverage re-visit time or the backhaul connection unavailability, e.g., indication 624. At 622, UE 602 may receive, from a network entity or base station 604, an indication of at least one of a coverage re-visit time or a backhaul connection unavailability, e.g., indication 624. The UE 602 may also obtain an indication of at least one of a coverage re-visit time or a backhaul connection unavailability, e.g., indication 624. The indication, e.g., indication 624, may be received via radio resource control (RRC) signaling or a system information block (SIB). At least one of the coverage re-visit time or the backhaul connection unavailability may be associated with a wait time information element. The data packet procedure may be associated with at least one of consumer internet of things (CIoT) data or a control plane service request (CPSR) procedure. The coverage re-visit time may be associated with a coverage area of at least one base station in the network, e.g., base station 604, and the backhaul connection unavailability may be associated with an unavailability of a backhaul connection between the at least one base station 604 and the network. The network entity may be associated with a satellite access network and at least one base station may in the satellite access network may be at least one satellite base station. The coverage re-visit time may correspond to an amount of time between a coverage of a first base station in a network and a coverage of a second base station in the network, where the network entity may be associated with the network. Also, the backhaul connection may correspond to a connection between at least one base station in a network and a backhaul portion of the network, where the network entity may be associated with the network.

In some aspects, the indication of at least one of the coverage re-visit time or the backhaul connection unavailability, e.g., 624, may be indicated from an access stratum (AS) layer to a non-access stratum (NAS) layer. The NAS layer may adjust at least one NAS supervision timer based on the coverage re-visit time. Also, the NAS layer may initiate a power saving mode for a duration of the coverage re-visit time.

At 630, UE 602 may identify, based on the received indication 624, whether to initiate at least one of the signaling procedure or the data packet procedure, where the at least one of the signaling procedure or the data packet procedure is initiated based on the identification whether to initiate at least one of the signaling procedure or the data packet procedure. The signaling procedure may be associated with at least one of a duration of the coverage re-visit time or a power saving mode.

At 640, UE 602 may initiate at least one of a signaling procedure or a data packet procedure based on the indication of at least one of the coverage re-visit time or the backhaul connection unavailability, each of the signaling procedure and the data packet procedure being associated with at least one of the coverage re-visit time or the backhaul connection unavailability.

At 650, UE 602 may initiate a timer for the duration of the coverage re-visit time; or initiate a power saving mode, e.g., when the signaling procedure is initiated. UE 602 may also adjust a length of the timer based on the duration of the coverage re-visit time, e.g., when the signaling procedure is initiated. UE 602 may also adjust a time interval between successive frequency scans, where the time interval between successive frequency scans is based on a duration of the coverage re-visit time.

At 660, UE 602 may initiate a transmission of at least one data packet, e.g., data packet 664; cancel a transmission of at least one data packet; or postpone a transmission of at least one data packet, e.g., when the data packet procedure is initiated. At 662, base station 604 may receive, from the at least one UE, at least one data packet, e.g., data packet 664. The transmission of the at least one data packet, e.g., data packet 664, may be associated with a data forwarding service and the postponed transmission of the at least one data packet may be associated with a data store-and-forward service. Also, a list of networks may be associated with at least one of the data forwarding service or the data store-and-forward service. UE 602 may also initiate a transmission of a registration request message associated with a registration procedure, where the registration procedure is initiated when the registration request message is transmitted; receive a registration accept message and an indication of support for at least one of the data store-and-forward service or the data forwarding service; and store the indication of support for at least one of the data store-and-forward service or the data forwarding service. In some instances, the UE 602 may obtain a registration accept message and an indication of support for at least one of the data store-and-forward service or the data forwarding service. Base station 604 may receive a registration request message associated with a registration procedure; and initiate a transmission of a registration accept message and an indication of support for at least one of the data store-and-forward service or the data forwarding service. In some instances, the base station 604 may obtain a registration request message associated with a registration procedure.

At 670, base station 604 may initiate a transmission of, to the at least one UE, an indication of a data transmission when the backhaul connection is available, e.g., indication 674, where a re-transmission of the data transmission is based on when the backhaul connection is available. At 672, UE 602 may receive, from the network entity, an indication of a data transmission when the backhaul connection is available, e.g., indication 674; and identify whether to re-transmit the data transmission when the backhaul connection is available. The UE 602 may re-transmit the data transmission when the backhaul connection is available. The base station 604 may receive the re-transmitted data transmission when the backhaul connection is available.

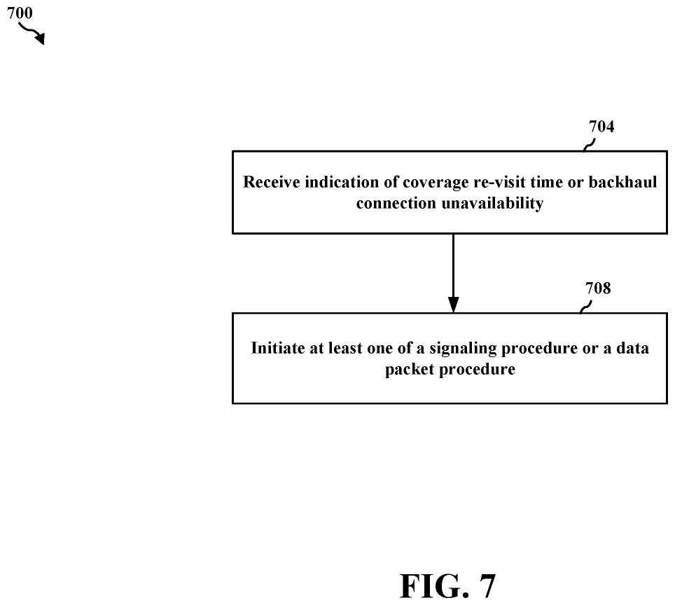

FIG. 7 is a flowchart 700 of a method of wireless communication. The method may be performed by an apparatus, such as a UE or a component of a UE (e.g., the UE 104, 350, 402/404, 502; apparatus 1102). The methods described herein may provide a number of benefits, such as improving communication signaling, resource utilization, and/or power savings.

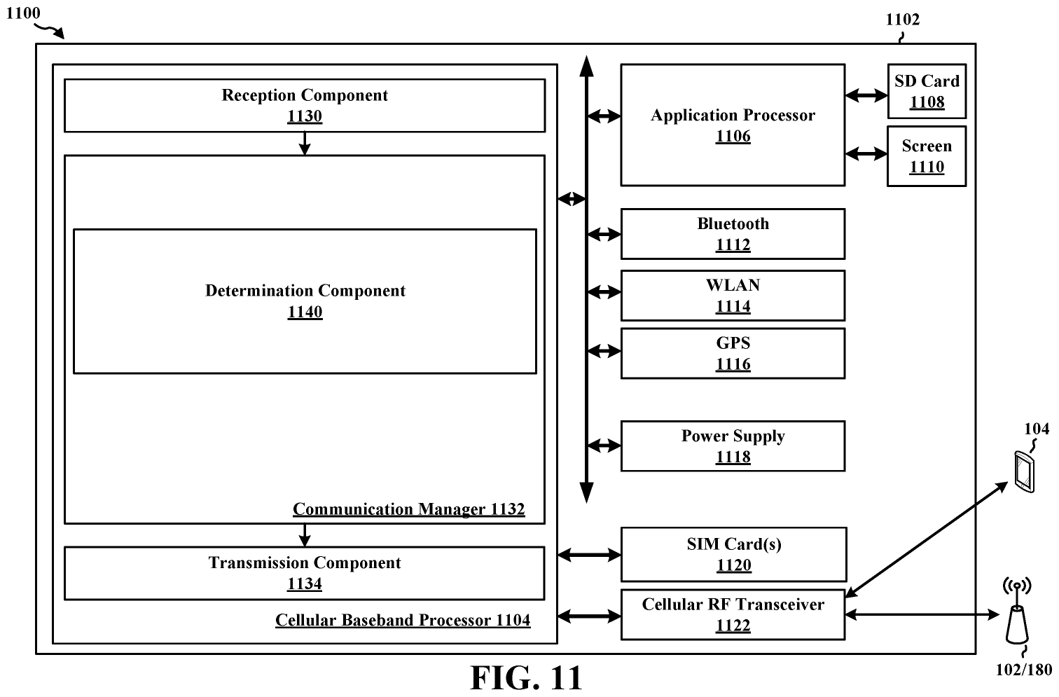

At 704, the UE may receive, from a network entity, an indication of at least one of a coverage re-visit time or a backhaul connection unavailability, as described in connection with the examples in FIGS. 4-6. For example, as described in 622 of FIG. 6, UE 602 may receive, from a network entity, an indication of at least one of a coverage re-visit time or a backhaul connection unavailability. Further, 704 may be performed by determination component 1140 in FIG. 11. The indication may be received via radio resource control (RRC) signaling or a system information block (SIB), as described in connection with the examples in FIGS. 4-6. At least one of the coverage re-visit time or the backhaul connection unavailability may be associated with a wait time information element, as described in connection with the examples in FIGS. 4-6. The data packet procedure may be associated with at least one of consumer internet of things (CIoT) data or a control plane service request (CPSR) procedure, as described in connection with the examples in FIGS. 4-6. The coverage re-visit time may be associated with a coverage area of at least one base station in the network and the backhaul connection unavailability may be associated with an unavailability of a backhaul connection between the at least one base station and the network, as described in connection with the examples in FIGS. 4-6. The network entity may be associated with a satellite access network and at least one base station in the satellite access network may be at least one satellite base station, as described in connection with the examples in FIGS. 4-6. The coverage re-visit time may correspond to an amount of time between a coverage of a first base station in a network and a coverage of a second base station in the network, where the network entity may be associated with the network. Also, the backhaul connection may correspond to a connection between at least one base station in a network and a backhaul portion of the network, where the network entity may be associated with the network.

In some aspects, the indication of at least one of the coverage re-visit time or the backhaul connection unavailability may be indicated from an access stratum (AS) layer to a non-access stratum (NAS) layer, as described in connection with the examples in FIGS. 4-6. The NAS layer may adjust at least one NAS supervision timer based on the coverage re-visit time, as described in connection with the examples in FIGS. 4-6. Also, the NAS layer may initiate a power saving mode for a duration of the coverage re-visit time, as described in connection with the examples in FIGS. 4-6.

At 708, the UE may initiate at least one of a signaling procedure or a data packet procedure based on the indication of at least one of the coverage re-visit time or the backhaul connection unavailability, each of the signaling procedure and the data packet procedure being associated with at least one of the coverage re-visit time or the backhaul connection unavailability, as described in connection with the examples in FIGS. 4-6. For example, as described in 640 of FIG. 6, UE 602 may initiate at least one of a signaling procedure or a data packet procedure based on the indication of at least one of the coverage re-visit time or the backhaul connection unavailability, each of the signaling procedure and the data packet procedure being associated with at least one of the coverage re-visit time or the backhaul connection unavailability. Further, 708 may be performed by determination component 1140 in FIG. 11.

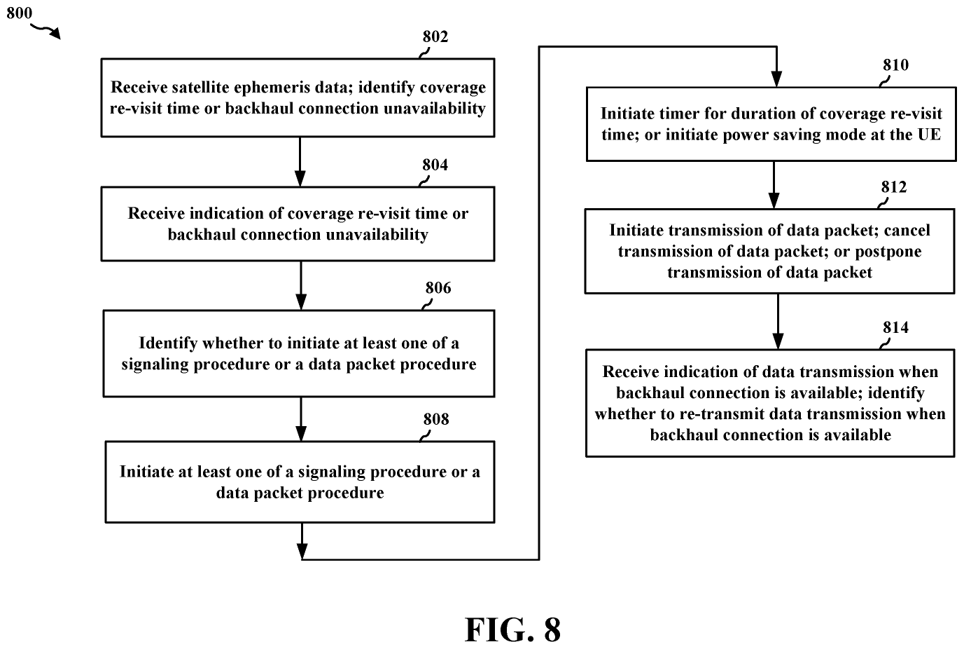

FIG. 8 is a flowchart 800 of a method of wireless communication. The method may be performed by an apparatus, such as a UE or a component of a UE (e.g., the UE 104, 350, 402/404, 502; apparatus 1102). The methods described herein may provide a number of benefits, such as improving communication signaling, resource utilization, and/or power savings.

At 802, the UE may receive, from a network entity, satellite ephemeris data; and identify at least one of a coverage re-visit time or a backhaul connection unavailability based on the satellite ephemeris data, as described in connection with the examples in FIGS. 4-6. For example, as described in 612 of FIG. 6, UE 602 may receive, from a network entity, satellite ephemeris data; and identify at least one of a coverage re-visit time or a backhaul connection unavailability based on the satellite ephemeris data. Further, 802 may be performed by determination component 1140 in FIG. 11. The UE or apparatus may also obtain satellite ephemeris data.

At 804, the UE may receive, from a network entity, an indication of at least one of a coverage re-visit time or a backhaul connection unavailability, as described in connection with the examples in FIGS. 4-6. For example, as described in 622 of FIG. 6, UE 602 may receive, from a network entity, an indication of at least one of a coverage re-visit time or a backhaul connection unavailability. The UE or apparatus may also obtain an indication of at least one of a coverage re-visit time or a backhaul connection unavailability. Further, 804 may be performed by determination component 1140 in FIG. 11. The indication may be received via radio resource control (RRC) signaling or a system information block (SIB), as described in connection with the examples in FIGS. 4-6. At least one of the coverage re-visit time or the backhaul connection unavailability may be associated with a wait time information element, as described in connection with the examples in FIGS. 4-6. The data packet procedure may be associated with at least one of consumer internet of things (CIoT) data or a control plane service request (CPSR) procedure, as described in connection with the examples in FIGS. 4-6. The coverage re-visit time may be associated with a coverage area of at least one base station in the network and the backhaul connection unavailability may be associated with an unavailability of a backhaul connection between the at least one base station and the network, as described in connection with the examples in FIGS. 4-6. The network entity may be associated with a satellite access network and at least one base station in the satellite access network may be at least one satellite base station, as described in connection with the examples in FIGS. 4-6. The coverage re-visit time may correspond to an amount of time between a coverage of a first base station in a network and a coverage of a second base station in the network, where the network entity may be associated with the network. Also, the backhaul connection may correspond to a connection between at least one base station in a network and a backhaul portion of the network, where the network entity may be associated with the network.

In some aspects, the indication of at least one of the coverage re-visit time or the backhaul connection unavailability may be indicated from an access stratum (AS) layer to a non-access stratum (NAS) layer, as described in connection with the examples in FIGS. 4-6. The NAS layer may adjust at least one NAS supervision timer based on the coverage re-visit time, as described in connection with the examples in FIGS. 4-6. Also, the NAS layer may initiate a power saving mode for a duration of the coverage re-visit time, as described in connection with the examples in FIGS. 4-6.

At 806, the UE may identify, based on the received indication, whether to initiate at least one of the signaling procedure or the data packet procedure, where the at least one of the signaling procedure or the data packet procedure is initiated based on the identification whether to initiate at least one of the signaling procedure or the data packet procedure, as described in connection with the examples in FIGS. 4-6. For example, as described in 630 of FIG. 6, UE 602 may identify, based on the received indication, whether to initiate at least one of the signaling procedure or the data packet procedure, where the at least one of the signaling procedure or the data packet procedure is initiated based on the identification whether to initiate at least one of the signaling procedure or the data packet procedure. Further, 806 may be performed by determination component 1140 in FIG. 11. The signaling procedure may be associated with at least one of a duration of the coverage re-visit time or a power saving mode, as described in connection with the examples in FIGS. 4-6. The data packet procedure may be associated with at least one of consumer internet of things (CIoT) data or a control plane service request (CPSR) procedure, as described in connection with the examples in FIGS. 4-6.

At 808, the UE may initiate at least one of a signaling procedure or a data packet procedure based on the indication of at least one of the coverage re-visit time or the backhaul connection unavailability, each of the signaling procedure and the data packet procedure being associated with at least one of the coverage re-visit time or the backhaul connection unavailability, as described in connection with the examples in FIGS. 4-6. For example, as described in 640 of FIG. 6, UE 602 may initiate at least one of a signaling procedure or a data packet procedure based on the indication of at least one of the coverage re-visit time or the backhaul connection unavailability, each of the signaling procedure and the data packet procedure being associated with at least one of the coverage re-visit time or the backhaul connection unavailability. Further, 808 may be performed by determination component 1140 in FIG. 11.

At 810, the UE may initiate a timer for the duration of the coverage re-visit time; or initiate a power saving mode, e.g., when the signaling procedure is initiated, as described in connection with the examples in FIGS. 4-6. For example, as described in 650 of FIG. 6, UE 602 may initiate a timer for the duration of the coverage re-visit time; or initiate the power saving mode at the UE. Further, 810 may be performed by determination component 1140 in FIG. 11. The UE or apparatus may also adjust a length of the timer based on the duration of the coverage re-visit time, e.g., when the signaling procedure is initiated, as described in connection with the examples in FIGS. 4-6. The UE or apparatus may also adjust a time interval between successive frequency scans of the apparatus, where the time interval between successive frequency scans is based on a duration of the coverage re-visit time, as described in connection with the examples in FIGS. 4-6.

At 812, the UE may initiate a transmission of at least one data packet; cancel a transmission of at least one data packet; or postpone a transmission of at least one data packet, e.g., when the data packet procedure is initiated, as described in connection with the examples in FIGS. 4-6. For example, as described in 660 of FIG. 6, UE 602 may initiate a transmission of at least one data packet; cancel a transmission of at least one data packet; or postpone a transmission of at least one data packet. Further, 812 may be performed by determination component 1140 in FIG. 11. The transmission of the at least one data packet may be associated with a data forwarding service and the postponed transmission of the at least one data packet may be associated with a data store-and-forward service, as described in connection with the examples in FIGS. 4-6. Also, a list of networks may be associated with at least one of the data forwarding service or the data store-and-forward service, as described in connection with the examples in FIGS. 4-6. The UE or apparatus may also initiate a transmission of a registration request message associated with a registration procedure, where the registration procedure is initiated when the registration request message is transmitted; receive a registration accept message and an indication of support for at least one of the data store-and-forward service or the data forwarding service; and store the indication of support for at least one of the data store-and-forward service or the data forwarding service, as described in connection with the examples in FIGS. 4-6. The UE or apparatus may also obtain a registration accept message and an indication of support for at least one of the data store-and-forward service or the data forwarding service.

At 814, the UE may receive, from the network entity, an indication of a data transmission when the backhaul connection is available; and identify whether to re-transmit the data transmission when the backhaul connection is available, as described in connection with the examples in FIGS. 4-6. For example, as described in 672 of FIG. 6, UE 602 may receive, from the network entity, an indication of a data transmission when the backhaul connection is available; and identify whether to re-transmit the data transmission when the backhaul connection is available. Further, 814 may be performed by determination component 1140 in FIG. 11. The UE or apparatus may also obtain an indication of a data transmission when the backhaul connection is available. The UE or apparatus may also re-transmit the data transmission when the backhaul connection is available, as described in connection with the examples in FIGS. 4-6.

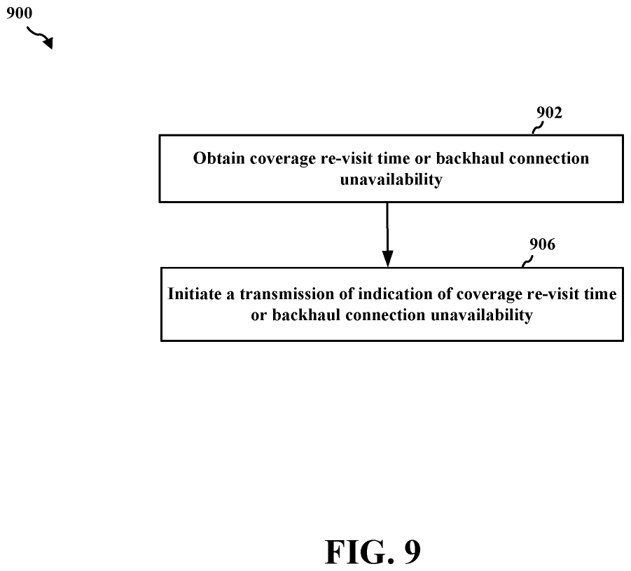

FIG. 9 is a flowchart 900 of a method of wireless communication. The method may be performed by an apparatus, such as a network entity, a component of a network entity, a base station, a component of a base station, a satellite, or a component of a satellite (e.g., the base station 180, 310, 410/420, 504/506; apparatus 1202). The methods described herein may provide a number of benefits, such as improving communication signaling, resource utilization, and/or power savings.

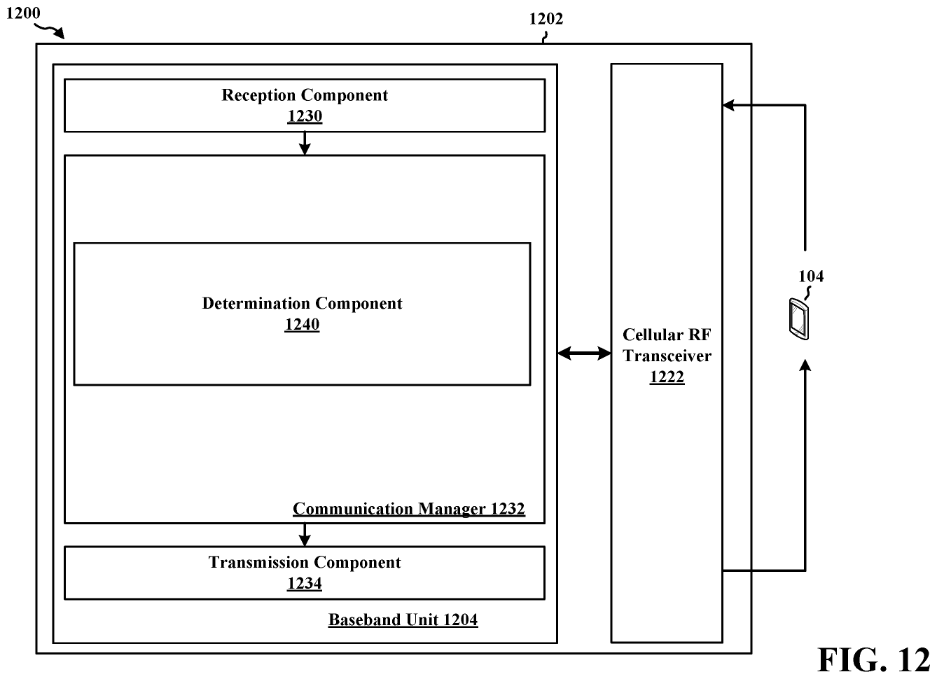

At 902, the network entity may obtain at least one of a coverage re-visit time or a backhaul connection unavailability, at least one of the coverage re-visit time or the backhaul connection unavailability being associated with at least one of a signaling procedure of at least one user equipment (UE) or a data packet procedure of the at least one UE, as described in connection with the examples in FIGS. 4-6. For example, as described in 610 of FIG. 6, base station 604 may obtain at least one of a coverage re-visit time or a backhaul connection unavailability, at least one of the coverage re-visit time or the backhaul connection unavailability being associated with at least one of a signaling procedure of at least one user equipment (UE) or a data packet procedure of the at least one UE. Further, 902 may be performed by determination component 1240 in FIG. 12. In some aspects, obtaining at least one of the coverage re-visit time or the backhaul connection unavailability may include at least one of: receiving a configuration of at least one of the coverage re-visit time or the backhaul connection unavailability; or retrieving the configuration of at least one of the coverage re-visit time or the backhaul connection unavailability from a storage or a memory location.

At 906, the network entity may initiate a transmission of an indication of at least one of the coverage re-visit time or the backhaul connection unavailability, as described in connection with the examples in FIGS. 4-6. For example, as described in 620 of FIG. 6, base station 604 may initiate a transmission of, to the at least one UE, an indication of at least one of the coverage re-visit time or the backhaul connection unavailability. Further, 906 may be performed by determination component 1240 in FIG. 12. The indication may be transmitted via radio resource control (RRC) signaling or a system information block (SIB), as described in connection with the examples in FIGS. 4-6. At least one of the coverage re-visit time or the backhaul connection unavailability may be associated with a wait time information element, as described in connection with the examples in FIGS. 4-6. The data packet procedure may be associated with at least one of consumer internet of things (CIoT) data or a control plane service request (CPSR) procedure, as described in connection with the examples in FIGS. 4-6. The coverage re-visit time may be associated with a coverage area of at least one base station in the network and the backhaul connection unavailability may be associated with an unavailability of a backhaul connection between the at least one UE and the at least one base station in the network, as described in connection with the examples in FIGS. 4-6. The network entity may be associated with a satellite access network and at least one base station in the satellite access network may be at least one satellite base station, as described in connection with the examples in FIGS. 4-6. The coverage re-visit time may correspond to an amount of time between a coverage of a first base station in a network and a coverage of a second base station in the network, where the network entity may be associated with the network. Also, the backhaul connection may correspond to a connection between at least one base station in a network and a backhaul portion of the network, where the network entity may be associated with the network.

In some aspects, the indication of at least one of the coverage re-visit time or the backhaul connection unavailability may be associated with an access stratum (AS) layer of at least one UE and a non-access stratum (NAS) layer of the at least one UE, as described in connection with the examples in FIGS. 4-6. At least one NAS supervision timer may be adjusted based on the coverage re-visit time, as described in connection with the examples in FIGS. 4-6. Also, a power saving mode at the NAS layer of the at least one UE may be initiated for a duration of the coverage re-visit time, as described in connection with the examples in FIGS. 4-6. The signaling procedure may be associated with at least one of a duration of the coverage re-visit time or a power saving mode at the UE, as described in connection with the examples in FIGS. 4-6. A timer for the duration of the coverage re-visit time may be initiated at the at least one UE or the power saving mode may be initiated at the at least one UE, as described in connection with the examples in FIGS. 4-6. Also, at least one of the duration of the coverage re-visit time or a time interval between successive frequency scans at the at least one UE may be adjusted, as described in connection with the examples in FIGS. 4-6.

Additionally, the data packet procedure may be associated with at least one of a transmission of at least one data packet, a canceled transmission of the at least one data packet, or a postponed transmission of the at least one data packet, as described in connection with the examples in FIGS. 4-6. The transmission of the at least one data packet may be associated with a data forwarding service and the postponed transmission of the at least one data packet may be associated with a data store-and-forward service, as described in connection with the examples in FIGS. 4-6. Also, a list of networks may be associated with at least one of the data forwarding service or the data store-and-forward service, as described in connection with the examples in FIGS. 4-6. The apparatus may also receive a registration request message associated with a registration procedure; and initiate a transmission of a registration accept message and an indication of support for at least one of the data store-and-forward service or the data forwarding service.

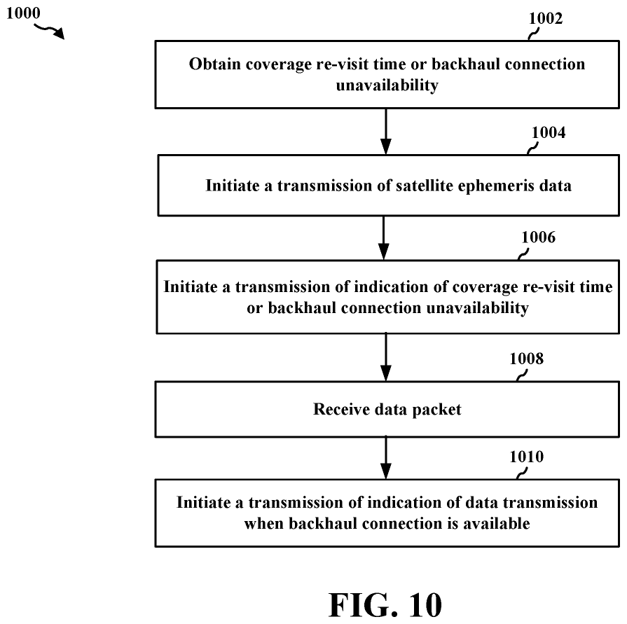

FIG. 10 is a flowchart 1000 of a method of wireless communication. The method may be performed by an apparatus, such as a network entity, a component of a network entity, a base station, a component of a base station, a satellite, or a component of a satellite (e.g., the base station 180, 310, 410/420, 504/506; apparatus 1202). The methods described herein may provide a number of benefits, such as improving communication signaling, resource utilization, and/or power savings.

At 1002, the network entity may obtain at least one of a coverage re-visit time or a backhaul connection unavailability, at least one of the coverage re-visit time or the backhaul connection unavailability being associated with at least one of a signaling procedure of at least one user equipment (UE) or a data packet procedure of the at least one UE, as described in connection with the examples in FIGS. 4-6. For example, as described in 610 of FIG. 6, base station 604 may obtain at least one of a coverage re-visit time or a backhaul connection unavailability, at least one of the coverage re-visit time or the backhaul connection unavailability being associated with at least one of a signaling procedure of at least one user equipment (UE) or a data packet procedure of the at least one UE. Further, 1002 may be performed by determination component 1240 in FIG. 12. In some aspects, obtaining at least one of the coverage re-visit time or the backhaul connection unavailability may include at least one of: receiving a configuration of at least one of the coverage re-visit time or the backhaul connection unavailability; or retrieving the configuration of at least one of the coverage re-visit time or the backhaul connection unavailability from a storage or a memory location. In some aspects, the network entity or apparatus may obtain a configuration of at least one of the coverage re-visit time or the backhaul connection unavailability.

At 1004, the network entity may transmit, to at least one UE, satellite ephemeris data, where at least one of the coverage re-visit time or the backhaul connection unavailability is based on the satellite ephemeris data, as described in connection with the examples in FIGS. 4-6. For example, as described in 611 of FIG. 6, base station 604 may transmit, to at least one UE, satellite ephemeris data, where at least one of the coverage re-visit time or the backhaul connection unavailability is based on the satellite ephemeris data. Further, 1004 may be performed by determination component 1240 in FIG. 12.

At 1006, the network entity may initiate a transmission of an indication of at least one of the coverage re-visit time or the backhaul connection unavailability, as described in connection with the examples in FIGS. 4-6. For example, as described in 620 of FIG. 6, base station 604 may initiate a transmission of, to the at least one UE, an indication of at least one of the coverage re-visit time or the backhaul connection unavailability. Further, 1006 may be performed by determination component 1240 in FIG. 12. The indication may be transmitted via radio resource control (RRC) signaling or a system information block (SIB), as described in connection with the examples in FIGS. 4-6. At least one of the coverage re-visit time or the backhaul connection unavailability may be associated with a wait time information element, as described in connection with the examples in FIGS. 4-6. The data packet procedure may be associated with at least one of consumer internet of things (CIoT) data or a control plane service request (CPSR) procedure, as described in connection with the examples in FIGS. 4-6. The coverage re-visit time may be associated with a coverage area of at least one base station in the network and the backhaul connection unavailability may be associated with an unavailability of a backhaul connection between the at least one UE and the at least one base station in the network, as described in connection with the examples in FIGS. 4-6. The network entity may be associated with a satellite access network and the at least one base station in the satellite access network may be at least one satellite base station, as described in connection with the examples in FIGS. 4-6. The coverage re-visit time may correspond to an amount of time between a coverage of a first base station in a network and a coverage of a second base station in the network, where the network entity may be associated with the network. Also, the backhaul connection may correspond to a connection between at least one base station in a network and a backhaul portion of the network, where the network entity may be associated with the network.

In some aspects, the indication of at least one of the coverage re-visit time or the backhaul connection unavailability may be associated with an access stratum (AS) layer of at least one UE and a non-access stratum (NAS) layer of the at least one UE, as described in connection with the examples in FIGS. 4-6. At least one NAS supervision timer may be adjusted based on the coverage re-visit time, as described in connection with the examples in FIGS. 4-6. Also, a power saving mode at the NAS layer of the at least one UE may be initiated for a duration of the coverage re-visit time, as described in connection with the examples in FIGS. 4-6.

The signaling procedure may be associated with at least one of a duration of the coverage re-visit time or a power saving mode at the UE, as described in connection with the examples in FIGS. 4-6. A timer for the duration of the coverage re-visit time may be initiated at the at least one UE or the power saving mode may be initiated at the at least one UE, as described in connection with the examples in FIGS. 4-6. Also, at least one of the duration of the coverage re-visit time or a time interval between successive frequency scans at the at least one UE may be adjusted, as described in connection with the examples in FIGS. 4-6.

The data packet procedure may be associated with at least one of a transmission of at least one data packet, a canceled transmission of the at least one data packet, or a postponed transmission of the at least one data packet, as described in connection with the examples in FIGS. 4-6. The transmission of the at least one data packet may be associated with a data forwarding service and the postponed transmission of the at least one data packet may be associated with a data store-and-forward service, as described in connection with the examples in FIGS. 4-6. Also, a list of networks may be associated with at least one of the data forwarding service or the data store-and-forward service, as described in connection with the examples in FIGS. 4-6. The network entity or apparatus may also receive a registration request message associated with a registration procedure; and initiate a transmission of a registration accept message and an indication of support for at least one of the data store-and-forward service or the data forwarding service. In some aspects, the network entity or apparatus may obtain a registration request message associated with a registration procedure.

At 1008, the network entity may receive, from the at least one UE, at least one data packet, as described in connection with the examples in FIGS. 4-6. For example, as described in 662 of FIG. 6, base station 604 may receive, from the at least one UE, at least one data packet. Further, 1008 may be performed by determination component 1240 in FIG. 12. The reception of the at least one data packet may be associated with a data forwarding service, as described in connection with the examples in FIGS. 4-6.

At 1010, the network entity may initiate a transmission of an indication of a data transmission when the backhaul connection is available, where a re-transmission of the data transmission is based on when the backhaul connection is available, as described in connection with the examples in FIGS. 4-6. For example, as described in 670 of FIG. 6, base station 604 may initiate a transmission of, to the at least one UE, an indication of a data transmission when the backhaul connection is available, where a re-transmission of the data transmission is based on when the backhaul connection is available. Further, 1010 may be performed by determination component 1240 in FIG. 12. The network entity or apparatus may also receive the re-transmitted data transmission when the backhaul connection is available, as described in connection with the examples in FIGS. 4-6.

FIG. 11 is a diagram 1100 illustrating an example of a hardware implementation for an apparatus 1102. The apparatus 1102 is a UE and includes a cellular baseband processor 1104 (also referred to as a modem) coupled to a cellular RF transceiver 1122 and one or more subscriber identity modules (SIM) cards 1120, an application processor 1106 coupled to a secure digital (SD) card 1108 and a screen 1110, a Bluetooth module 1112, a wireless local area network (WLAN) module 1114, a Global Positioning System (GPS) module 1116, and a power supply 1118. The cellular baseband processor 1104 communicates through the cellular RF transceiver 1122 with the UE 104 and/or BS 102/180. The cellular baseband processor 1104 may include a computer-readable medium/memory. The computer-readable medium/memory may be non-transitory. The cellular baseband processor 1104 is responsible for general processing, including the execution of software stored on the computer-readable medium/memory. The software, when executed by the cellular baseband processor 1104, causes the cellular baseband processor 1104 to perform the various functions described supra. The computer-readable medium/memory may also be used for storing data that is manipulated by the cellular baseband processor 1104 when executing software. The cellular baseband processor 1104 further includes a reception component 1130, a communication manager 1132, and a transmission component 1134. The communication manager 1132 includes the one or more illustrated components. The components within the communication manager 1132 may be stored in the computer-readable medium/memory and/or configured as hardware within the cellular baseband processor 1104. The cellular baseband processor 1104 may be a component of the UE 350 and may include the memory 360 and/or at least one of the TX processor 368, the RX processor 356, and the controller/processor 359. In one configuration, the apparatus 1102 may be a modem chip and include just the baseband processor 1104, and in another configuration, the apparatus 1102 may be the entire UE (e.g., see 350 of FIG. 3) and include the aforediscussed additional modules of the apparatus 1102.

The communication manager 1132 includes a determination component 1140 that may be configured to receive, from the network entity, satellite ephemeris data; and identify at least one of the coverage re-visit time or the backhaul connection unavailability based on the satellite ephemeris data, e.g., as described in connection with 802 in FIG. 8. Determination component 1140 may also be configured to receive, from a network entity, an indication of at least one of a coverage re-visit time or a backhaul connection unavailability, e.g., as described in connection with 804 in FIG. 8. Determination component 1140 may also be configured to identify, based on the received indication, whether to initiate at least one of the signaling procedure or the data packet procedure, where the at least one of the signaling procedure or the data packet procedure is initiated based on the identification whether to initiate at least one of the signaling procedure or the data packet procedure, e.g., as described in connection with 806 in FIG. 8. Determination component 1140 may also be configured to initiate at least one of a signaling procedure or a data packet procedure based on the indication of at least one of the coverage re-visit time or the backhaul connection unavailability, each of the signaling procedure and the data packet procedure being associated with at least one of the coverage re-visit time or the backhaul connection unavailability, e.g., as described in connection with 808 in FIG. 8. Determination component 1140 may also be configured to initiate a timer for the duration of the coverage re-visit time; or initiate the power saving mode at the UE, e.g., as described in connection with 810 in FIG. 8. Determination component 1140 may also be configured to adjust a length of the timer based on the duration of the coverage re-visit time. Determination component 1140 may also be configured to initiate a transmission of at least one data packet; cancel a transmission of at least one data packet; or postpone a transmission of at least one data packet, e.g., as described in connection with 812 in FIG. 8. Determination component 1140 may also be configured to receive, from the network entity, an indication of a data transmission when the backhaul connection is available; and identify whether to re-transmit the data transmission when the backhaul connection is available, e.g., as described in connection with 814 in FIG. 8.

The apparatus may include additional components that perform each of the blocks of the algorithm in the aforementioned flowcharts of FIGS. 6-8. As such, each block in the aforementioned flowcharts of FIGS. 6-8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1102, and in particular the cellular baseband processor 1104, includes means for receiving, from the network entity, satellite ephemeris data; means for identifying at least one of the coverage re-visit time or the backhaul connection unavailability based on the satellite ephemeris data; means for receiving, from a network entity, an indication of at least one of a coverage re-visit time or a backhaul connection unavailability; means for identifying, based on the received indication, whether to initiate at least one of the signaling procedure or the data packet procedure, where the identification whether to initiate at least one of the signaling procedure or the data packet procedure is performed prior to the initiation of the at least one of a signaling procedure or a data packet procedure; means for initiating at least one of a signaling procedure or a data packet procedure based on the indication of at least one of the coverage re-visit time or the backhaul connection unavailability, the signaling procedure and the data packet procedure being associated with at least one of the coverage re-visit time or the backhaul connection unavailability; means for initiating a timer for the duration of the coverage re-visit time; means for initiating the power saving mode at the UE; means for adjusting a length of the timer based on the duration of the coverage re-visit time; means for transmitting at least one data packet; means for canceling a transmission of at least one data packet; means for postponing a transmission of at least one data packet; means for receiving, from the network entity, an indication of a data transmission when the backhaul connection is available; means for identifying whether to re-transmit the data transmission when the backhaul connection is available; means for adjusting a time interval between successive frequency scans at the UE, where the time interval between successive frequency scans corresponds to the duration of the coverage re-visit time; means for transmitting a registration request message associated with a registration procedure, where the registration procedure is initiated when the registration request message is transmitted; means for receiving a registration accept message and an indication of support for at least one of the data store-and-forward service or the data forwarding service; and means for storing the indication of support for at least one of the data store-and-forward service or the data forwarding service. The aforementioned means may be one or more of the aforementioned components of the apparatus 1102 configured to perform the functions recited by the aforementioned means. As described supra, the apparatus 1102 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

FIG. 12 is a diagram 1200 illustrating an example of a hardware implementation for an apparatus 1202. The apparatus 1202 is a base station (BS) and includes a baseband unit 1204. The baseband unit 1204 may communicate through a cellular RF transceiver 1222 with the UE 104. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204. The baseband unit 1204 may be a component of the BS 310 and may include the memory 376 and/or at least one of the TX processor 316, the RX processor 370, and the controller/processor 375.

The communication manager 1232 includes a determination component 1240 that may be configured to obtain at least one of a coverage re-visit time or a backhaul connection unavailability, at least one of the coverage re-visit time or the backhaul connection unavailability being associated with at least one of a signaling procedure of at least one user equipment (UE) or a data packet procedure of the at least one UE, e.g., as described in connection with 1002 in FIG. 10. Determination component 1240 may also be configured to transmit, to the at least one UE, satellite ephemeris data, where at least one of the coverage re-visit time or the backhaul connection unavailability is based on the satellite ephemeris data, e.g., as described in connection with 1004 in FIG. 10. Determination component 1240 may also be configured to initiate a transmission of, to the at least one UE, an indication of at least one of the coverage re-visit time or the backhaul connection unavailability, e.g., as described in connection with 1006 in FIG. 10. Determination component 1240 may also be configured to receive at least one data packet, e.g., as described in connection with 1008 in FIG. 10. Determination component 1240 may also be configured to initiate a transmission of, to the at least one UE, an indication of a data transmission when the backhaul connection is available, where a re-transmission of the data transmission is based on when the backhaul connection is available, e.g., as described in connection with 1010 in FIG. 10.

The apparatus may include additional components that perform each of the blocks of the algorithm in the aforementioned flowcharts of FIGS. 6, 9, and 10. As such, each block in the aforementioned flowcharts of FIGS. 6, 9, and 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the baseband unit 1204, includes means for obtaining at least one of a coverage re-visit time or a backhaul connection unavailability, at least one of the coverage re-visit time or the backhaul connection unavailability being associated with at least one of a signaling procedure of at least one user equipment (UE) or a data packet procedure of the at least one UE; means for receiving a configuration of at least one of the coverage re-visit time or the backhaul connection unavailability; means for retrieving the configuration of at least one of the coverage re-visit time or the backhaul connection unavailability from a storage or a memory location; means for transmitting, to the at least one UE, satellite ephemeris data, where at least one of the coverage re-visit time or the backhaul connection unavailability is based on the satellite ephemeris data; means for transmitting, to the at least one UE, an indication of at least one of the coverage re-visit time or the backhaul connection unavailability; means for receiving at least one data packet; means for transmitting, to the at least one UE, an indication of a data transmission when the backhaul connection is available, where a re-transmission of the data transmission is based on when the backhaul connection is available; means for receiving a registration request message associated with a registration procedure; and means for transmitting a registration accept message and an indication of support for at least one of the data store-and-forward service or the data forwarding service. The aforementioned means may be one or more of the aforementioned components of the apparatus 1202 configured to perform the functions recited by the aforementioned means. As described supra, the apparatus 1202 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1: A method of wireless communication at a user equipment (UE), comprising: receiving, from a network entity, an indication of at least one of a coverage re-visit time or a backhaul connection unavailability; and initiating at least one of a signaling procedure or a data packet procedure based on the indication of at least one of the coverage re-visit time or the backhaul connection unavailability, each of the signaling procedure and the data packet procedure being associated with at least one of the coverage re-visit time or the backhaul connection unavailability.

Aspect 2: The method of aspect 1, further including identifying, based on the received indication, whether to initiate at least one of the signaling procedure or the data packet procedure, where the at least one of the signaling procedure or the data packet procedure is initiated based on the identification whether to initiate at least one of the signaling procedure or the data packet procedure;

Aspect 3: The method of any of aspects 1 and 2, where the signaling procedure is associated with at least one of a duration of the coverage re-visit time or a power saving mode.

Aspect 4: The method of aspect 3, where when the signaling procedure is initiated, the method further including: initiating a timer for the duration of the coverage re-visit time; or initiating the power saving mode.

Aspect 5: The method of aspect 4, further including adjusting a length of the timer based on the duration of the coverage re-visit time.

Aspect 6: The method of any of aspects 1 to 5, further comprising: adjusting a time interval between successive frequency scans of the apparatus, where the time interval between successive frequency scans corresponds to the duration of the coverage re-visit time.

Aspect 7: The method of any of aspects 1 to 6, where the data packet procedure is initiated, the method further including initiating a transmission of at least one data packet; canceling a transmission of at least one data packet; or postponing a transmission of at least one data packet.

Aspect 8: The method of aspect 7, where the transmission of the at least one data packet is associated with a data forwarding service and the postponed transmission of the at least one data packet is associated with a data store-and-forward service.

Aspect 9: The method of aspect 8, where a list of networks is associated with at least one of the data forwarding service or the data store-and-forward service.

Aspect 10: The method of aspect 8, further comprising: initiating a transmission of a registration request message associated with a registration procedure, where the registration procedure is initiated when the registration request message is transmitted; receiving a registration accept message and an indication of support for at least one of the data store-and-forward service or the data forwarding service; and storing the indication of support for at least one of the data store-and-forward service or the data forwarding service.

Aspect 11: The method of any of aspects 1 to 10, further comprising: receiving, from the network entity, satellite ephemeris data; and identifying at least one of the coverage re-visit time or the backhaul connection unavailability based on the satellite ephemeris data.

Aspect 12: The method of any of aspects 1 to 11, where the indication is received via radio resource control (RRC) signaling or a system information block (SIB).

Aspect 13: The method of any of aspects 1 to 12, where the indication of at least one of the coverage re-visit time or the backhaul connection unavailability is indicated from an access stratum (AS) layer to a non-access stratum (NAS) layer.

Aspect 14: The method of any of aspects 1 to 13, where at least one NAS supervision timer is adjusted based on the coverage re-visit time.

Aspect 15: The method of any of aspects 1 to 14, where a power saving mode is initiated for a duration of the coverage re-visit time.

Aspect 16: The method of any of aspects 1 to 15, where the data packet procedure is associated with at least one of consumer internet of things (CIoT) data or a control plane service request (CPSR) procedure.

Aspect 17: The method of aspect 16, further comprising: receiving, from the network, an indication of a data transmission when the backhaul connection is available; and re-transmitting the data transmission based on the received indication.

Aspect 18: The method of any of aspects 1 to 17, where the coverage re-visit time is associated with a coverage area of at least one base station in the network and the backhaul connection unavailability is associated with an unavailability of a backhaul connection between the at least one base station and the network.

Aspect 19: The method of any of aspects 1 to 18, where the network entity is associated with a satellite access network and at least one base station in the satellite access network is at least one satellite base station.

Aspect 20: The method of any of aspects 1 to 19, where the coverage re-visit time corresponds to an amount of time between a coverage of a first base station in a network and a coverage of a second base station in the network, where the network entity is associated with the network.

Aspect 21: The method of any of aspects 1 to 20, where the backhaul connection corresponds to a connection between at least one base station in a network and a backhaul portion of the network, where the network entity is associated with the network.

Aspect 22: A method of wireless communication at a network device or a network entity, comprising: obtaining at least one of a coverage re-visit time or a backhaul connection unavailability, at least one of the coverage re-visit time or the backhaul connection unavailability being associated with at least one of a signaling procedure of at least one user equipment (UE) or a data packet procedure of the at least one UE; and initiating a transmission of an indication of at least one of the coverage re-visit time or the backhaul connection unavailability.

Aspect 23: The method of aspect 22, where the signaling procedure is associated with at least one of a duration of the coverage re-visit time or a power saving mode at the at least one UE.

Aspect 24: The method of any of aspects 22 to 23, where a timer for the duration of the coverage re-visit time is initiated at the at least one UE or the power saving mode is initiated at the at least one UE.

Aspect 25: The method of any of aspects 22 to 24, where at least one of a length of a timer based on the duration of the coverage re-visit time or a time interval between successive frequency scans at the at least one UE is adjusted.

Aspect 26: The method of any of aspects 22 to 25, where the data packet procedure is associated with at least one of a transmission of at least one data packet, a canceled transmission of the at least one data packet, or a postponed transmission of the at least one data packet.

Aspect 27: The method of any of aspects 22 to 26, where the transmission of the at least one data packet is associated with a data forwarding service and the postponed transmission of the at least one data packet is associated with a data store-and-forward service.

Aspect 28: The method of any of aspects 22 to 27, further comprising: initiating a transmission of satellite ephemeris data, where at least one of the coverage re-visit time or the backhaul connection unavailability is based on the satellite ephemeris data.

Aspect 29: The method of any of aspects 22 to 28, where the indication is transmitted via radio resource control (RRC) signaling or a system information block (SIB).

Aspect 30: The method of any of aspects 22 to 29, where at least one of the coverage re-visit time or the backhaul connection unavailability is associated with a wait time information element.

Aspect 31: The method of any of aspects 22 to 30, where the indication of at least one of the coverage re-visit time or the backhaul connection unavailability is associated with an access stratum (AS) layer of the at least one UE and a non-access stratum (NAS) layer of the at least one UE.

Aspect 32: The method of any of aspects 22 to 31, where at least one NAS supervision timer is adjusted based on the coverage re-visit time.

Aspect 33: The method of any of aspects 22 to 32, where a power saving mode at the NAS layer of the at least one UE is initiated for a duration of the coverage re-visit time.

Aspect 34: The method of any of aspects 22 to 33, where the data packet procedure is associated with at least one of consumer internet of things (CIoT) data or a control plane service request (CPSR) procedure.

Aspect 35: The method of any of aspects 22 to 34, further comprising: initiating a transmission of an indication of a data transmission when the backhaul connection is available, where a re-transmission of the data transmission is based on when the backhaul connection is available.

Aspect 36: The method of any of aspects 22 to 35, where the coverage re-visit time is associated with a coverage area of at least one base station in the network and the backhaul connection unavailability is associated with an unavailability of a backhaul connection between the at least one UE and the at least one base station in the network.

Aspect 37: The method of any of aspects 22 to 36, where the at least one of the coverage re-visit time or the backhaul connection unavailability is obtained via a configuration.

Aspect 38: The method of aspect 37, where obtaining at least one of the coverage re-visit time or the backhaul connection unavailability may include: retrieving the configuration of at least one of the coverage re-visit time or the backhaul connection unavailability from a storage or a memory location.

Aspect 39: The method of aspect 38, where a list of networks is associated with at least one of the data forwarding service or the data store-and-forward service.

Aspect 40: The method of aspect 38, further comprising: receiving a registration request message associated with a registration procedure; and initiating a transmission of a registration accept message and an indication of support for at least one of the data store-and-forward service or the data forwarding service.

Aspect 41: An apparatus for wireless communications, comprising: a memory comprising instructions; and at least one processor configured to execute the instructions and cause the apparatus to perform a method in accordance with any one of Aspects 1-21.

Aspect 42: An apparatus for wireless communications, comprising: a memory comprising instructions; and at least one processor configured to execute the instructions and cause the apparatus to perform a method in accordance with any one of Aspects 22-40.

Aspect 43: A user equipment (UE), comprising: at least one transceiver; a memory comprising instructions; and at least one processor configured to execute the instructions and cause the UE to perform a method in accordance with any one of Aspects 1-21, where the at least one transceiver is configured to transmit or receive the indication.

Aspect 44: A network device or network entity, comprising: at least one transceiver; a memory comprising instructions; and at least one processor configured to execute the instructions and cause the network device or network entity to perform a method in accordance with any one of Aspects 22-40, where the at least one transceiver is configured to transmit or receive the indication, where at least one of the coverage re-visit time or the backhaul connection unavailability is obtained via the at least one transceiver.

Aspect 45: An apparatus for wireless communications, comprising means for performing a method in accordance with any one of Aspects 1-21.

Aspect 46: An apparatus for wireless communications, comprising means for performing a method in accordance with any one of Aspects 22-40.

Aspect 47: A non-transitory computer-readable medium comprising instructions that, when executed by an apparatus, cause the apparatus to perform a method in accordance with any one of Aspects 1-21.

Aspect 48: A non-transitory computer-readable medium comprising instructions that, when executed by an apparatus, cause the apparatus to perform a method in accordance with any one of Aspects 22-40.

1. An apparatus for wireless communication, comprising:
a memory comprising instructions; and
at least one processor configured to execute the instructions and cause the apparatus to:
receive, from a network entity, an indication of at least one of a coverage re-visit time or a backhaul connection unavailability; and
initiate at least one of a signaling procedure or a data packet procedure based on the indication of at least one of the coverage re-visit time or the backhaul connection unavailability, each of the signaling procedure and the data packet procedure being associated with at least one of the coverage re-visit time or the backhaul connection unavailability.

2. The apparatus of claim 1, wherein the at least one processor is further configured to cause the apparatus to:
identify, based on the received indication, whether to initiate at least one of the signaling procedure or the data packet procedure, wherein the at least one of the signaling procedure or the data packet procedure is initiated based on the identification whether to initiate at least one of the signaling procedure or the data packet procedure.

3. The apparatus of claim 1, wherein the signaling procedure is associated with at least one of a duration of the coverage re-visit time or a power saving mode.

4. The apparatus of claim 3, wherein when the signaling procedure is initiated, the at least one processor is further configured to cause the apparatus to:
initiate a timer for the duration of the coverage re-visit time; or
initiate the power saving mode.

5. The apparatus of claim 4, wherein the at least one processor is further configured to cause the apparatus to:
adjust a length of the timer based on the duration of the coverage re-visit time.

6. The apparatus of claim 1, wherein the at least one processor is further configured to cause the apparatus to:
adjust a time interval between successive frequency scans of the apparatus, wherein the time interval between the successive frequency scans is based on a duration of the coverage re-visit time.

7. The apparatus of claim 1, wherein when the data packet procedure is initiated, the at least one processor is further configured to cause the apparatus to:
initiate a transmission of at least one data packet;
cancel the transmission of the at least one data packet; or
postpone the transmission of the at least one data packet.

8. The apparatus of claim 7, wherein the transmission of the at least one data packet is associated with a data forwarding service and the postponed transmission of the at least one data packet is associated with a data store-and-forward service.

9. The apparatus of claim 8, wherein a list of networks is associated with at least one of the data forwarding service or the data store-and-forward service.

10. The apparatus of claim 8, wherein the at least one processor is further configured to cause the apparatus to:
initiate a transmission of a registration request message associated with a registration procedure, wherein the registration procedure is initiated when the registration request message is transmitted;
receive a registration accept message and an indication of support for at least one of the data store-and-forward service or the data forwarding service; and
store the indication of the support for at least one of the data store-and-forward service or the data forwarding service.

11. The apparatus of claim 1, wherein the at least one processor is further configured to cause the apparatus to:
receive, from the network entity, satellite ephemeris data; and
identify at least one of the coverage re-visit time or the backhaul connection unavailability based on the satellite ephemeris data.

12. The apparatus of claim 1, wherein the indication is received via radio resource control (RRC) signaling or a system information block (SIB).

13. The apparatus of claim 1, wherein the at least one processor adjusts at least one non-access stratum (NAS) supervision timer based on the coverage re-visit time.

14. The apparatus of claim 1, wherein the at least one processor initiates a power saving mode for a duration of the coverage re-visit time.

15. The apparatus of claim 1, wherein the data packet procedure is associated with at least one of consumer internet of things (CIoT) data or a control plane service request (CPSR) procedure.

16. The apparatus of claim 15, wherein the at least one processor is further configured to cause the apparatus to:
receive, from the network entity, an indication of a data transmission when the backhaul connection is available; and
re-transmit the data transmission based on the received indication.

17. The apparatus of claim 1, wherein the coverage re-visit time corresponds to an amount of time between a coverage of a first base station in a network and a coverage of a second base station in the network, wherein the network entity is associated with the network.

18. The apparatus of claim 1, further comprising at least one transceiver via which the indication is received, wherein the apparatus is configured as a user equipment (UE).

19. A method of wireless communication at a user equipment (UE), comprising:
receiving, from a network entity, an indication of at least one of a coverage re-visit time or a backhaul connection unavailability; and
initiating at least one of a signaling procedure or a data packet procedure based on the indication of at least one of the coverage re-visit time or the backhaul connection unavailability, the signaling procedure and the data packet procedure being associated with at least one of the coverage re-visit time or the backhaul connection unavailability.

20. (canceled)

21. (canceled)

22. (canceled)

23. An apparatus for wireless communication, comprising:
a memory comprising instructions; and
at least one processor coupled configured to execute the instructions and cause the apparatus to:
obtain at least one of a coverage re-visit time or a backhaul connection unavailability, at least one of the coverage re-visit time or the backhaul connection unavailability being associated with at least one of a signaling procedure of at least one user equipment (UE) or a data packet procedure of the at least one UE; and
initiate a transmission of an indication of at least one of the coverage re-visit time or the backhaul connection unavailability.

24. (canceled)

25. (canceled)

26. (canceled)

27. (canceled)

28. (canceled)

29. (canceled)

30. (canceled)
